(19) United States
(12) Patent Application Publication
(10) Pub. No.: US 2025/0058826 A1
(43) Pub. Date: Feb. 20, 2025

(54) METHOD FOR ASCERTAINING A CONTROLLER STEERING TORQUE TO BE PREDEFINED FOR A STEERING ACTUATOR OF A MOTOR VEHICLE

(71) Applicant: Robert Bosch GmbH, Stuttgart (DE)

(72) Inventor: Pratiksh Bolia, Heilbronn (DE)

(21) Appl. No.: 18/791,667

(22) Filed: Aug. 1, 2024

(30) Foreign Application Priority Data
Aug. 18, 2023 (DE) 10 2023 207 928.3

(51) Int. Cl. B62D 6/00; B62D 5/04

(52) U.S. Cl. CPC B62D 6/002; B62D 5/0463

(57) ABSTRACT

A method for ascertaining a controller steering torque to be predefined for a steering actuator. The controller steering torque is ascertained using a dual controller which includes an external controller and an internal controller connected downstream of the external controller. A steering angle set by the steering actuator in the motor vehicle is fed to the external controller as a control variable. The external controller outputs a target value of the time derivative of the steering angle as a manipulated variable. The internal controller is fed with a pilot control model steering torque for the calculation of the manipulated variable according to the present invention, which is determined in real time as a function of the physical behavior of the steering actuator. The physical state of the steering actuator is modeled by a rotational single-mass spring damper with external excitation. The second-dependent steering angle is the free parameter.

### FIELD

The present invention relates to a method for ascertaining a controller steering torque to be predefined for a steering actuator of a motor vehicle. The present invention also relates to a control device that is configured/programmed for carrying out this method. Finally, the present invention relates to a motor vehicle with such a control device.

### BACKGROUND INFORMATION

In connection with so-called steering angle or lane keeping assistants of motor vehicles, the steering angle to be set in a steering actuator of a steering device may be set taking into account different factors, in such a way that the motor vehicle follows the course of a predefined trajectory when driving on a roadway. Methods for ascertaining a steering torque to be set in a steering actuator are described in the related art. Such conventional methods generally work with a one-stage or two-stage controller and are described, for example, in European Patent No. EP 3 321 149 B1, in U.S. Patent Application Publication No. US 2019/0308664 A1 and in German Patent Application No. DE 10 2014 208 786 A1.

The problem with such conventional methods is that the physical properties of the steering actuator influence the control and thus the actual steering behavior of the steering actuator to a not inconsiderable extent, which can have a detrimental effect on the control behavior of the controller.

Corresponding modeling of the physical properties of the steering actuator, which is implemented in the controller in the form of a so-called forward model to improve control performance, has proven to be comparatively inaccurate in practice and does not take into account changes in the physical properties of the steering actuator over the service life of the steering device.

It is an object of the present invention to provide an improved method for determining a controller steering torque to be predefined for a steering actuator of a motor vehicle, with which the above-mentioned disadvantage is at least partially, ideally even completely, eliminated.

This object may be achieved by features of the present invention. Preferred embodiments of the present invention are disclosed herein.

### SUMMARY

A basic feature of the present invention is to determine a controller steering torque for a steering actuator with the aid of a dual controller, wherein an external controller uses a steering angle set by the steering actuator in the motor vehicle as a control variable and an internal controller uses the time derivative of this steering angle as a control variable.

According to an example embodiment of the present invention, it is proposed to provide the internal controller with a pilot control model steering torque as an additional input variable, by means of which the current physical properties of the steering actuator are taken into account in real time. It is further proposed to model the physical properties of the steering device in a time-dependent manner using a rotational single-mass spring damper with external excitation and with different spring damper model parameters. The selected time-dependent spring damper model parameters are estimated by means of a recursive compensation calculation for the calculation of the pilot control model steering torque to be fed to the internal controller. The control behavior of the two-stage controller can be significantly improved by taking into account the physical properties of the steering actuator, which is substantial to the present invention as presented here. This has an advantageous effect on the steering control of the motor vehicle assisted or even autonomous driving of motor vehicles.

The method according to the present invention is used to ascertain a controller steering torque to be predefined for a steering actuator of a motor vehicle. According to an example embodiment of the method of the present invention, the desired controller steering torque is ascertained with the aid of a dual controller, which comprises an external controller and an internal controller connected downstream of the external controller. A steering angle set by the steering actuator in the motor vehicle is fed to the external controller as a control variable. The external controller outputs a target value of the time derivative of the steering angle as a manipulated variable, which is used as a control variable for the internal controller. In addition, a pilot control model steering torque is fed to the internal controller for the calculation of the manipulated variable, which is determined in real time as a function of the physical behavior of the steering actuator.

The physical state of the steering device is modeled by a rotational single-mass spring damper with external excitation. Here, the time-dependent steering angle is a free parameter of the model. In addition, at least one further time-dependent spring damper model parameter is used for the physical description of the spring damper. According to the present invention, the at least one time-dependent spring damper model parameter is estimated by means of recursive compensation calculation. The pilot control model steering torque to be provided to the internal controller is determined from this estimate.

Here, the at least one time-dependent spring damper model parameter is estimated by means of recursive compensation calculation. The pilot control model steering torque to be provided to the internal controller is calculated from this estimate.

With a preferred embodiment of the method according to the present invention, the pilot control model steering torque is calculated as part of the control loop of the internal controller. As a result, the accuracy of the internal controller is increased.

According to an example embodiment of the present invention, particularly preferably, the pilot control model steering torque is calculated as a function of the target value of the steering angle, the controller steering torque calculated by the internal controller, and the driver steering torque exerted by the driver of the motor vehicle. This is accompanied by a particularly precise control result. The driver steering torque can depend on the steering angle and other system states.

According to a further preferred embodiment of the present invention, the following constants used in the rotational single-mass spring damper are estimated as time-dependent variables as spring damper model parameters: the time-dependent rotational moment of inertia J(t), the time-dependent damping D(t), the time-dependent stiffness C(t), and a time-dependent offset Offs(t).

With a preferred embodiment of the present invention, the internal controller uses the change in steering angle as a reference variable and calculates the desired controller steering torque not only as a function of an ascertained target/actual deviation of the reference variable, but also as a function of the ascertained pilot control model steering torque as a manipulated variable. Taking into account the pilot control model steering torque leads to a significantly improved control behavior of the two controllers.

With another preferred embodiment of the present invention, the external controller can use the steering angle set in the steering actuator as a reference variable. With this embodiment, the external controller also outputs the change in steering angle as a manipulated variable.

With the method according to the present invention, the estimation of the preceding spring damper model parameters is preferably effected in real time. This makes it possible to react to changes in the physical properties of the steering actuator that occur in real time, which improves the control behavior of the two controllers.

Particularly preferably, the pilot control model steering torque can be ascertained from the estimated stiffness and the estimated offset as a function of an externally predefined target steering angle.

According to an advantageous further development of the method according to the present invention, the at least one spring damper model parameter J(t), D(t), C(t), Offs(t) is ascertained by means of a Kalman filter. By means of a Kalman filter, the spring damper model parameters can be estimated particularly accurately, in particular in real time.

According to an advantageous further development of the method according to the present invention, the externally excited single-mass spring damper is described by the following differential equation:

$$J \ddot{δ} + D \dot{δ} + C δ + Offs = {Tmot ( t )}_{SAC + Driver}$$

With a particularly preferred variant of the method according to the present invention, the external excitation of the spring damper can be specified by the sum of a driver steering torque set by the driver and the controller steering torque to be predefined for the steering actuator. With this variant, the driver steering torque set by the driver is taken into account.

The present invention also relates to a control device for a motor vehicle, which is configured/programmed for carrying out the method according to the present invention presented above. Therefore, the advantages of the method according to the present invention explained above are transferred to the control device according to the present invention.

The present invention also relates to a motor vehicle with two front wheels and two rear wheels and with a steering actuator for setting a steering angle in the front wheels that specifies the direction of travel of the motor vehicle. The motor vehicle also comprises a sensor system for determining the currently set steering angle. The sensor system can comprise a steering angle sensor for this purpose. According to the present invention, the motor vehicle according to the present invention also comprises a control device that interacts with the steering actuator and with the sensor system and that is presented above and thus according to the present invention. Therefore, the advantages of the method according to the present invention explained above are transferred to the motor vehicle according to the present invention.

Further important features and advantages of the present invention can be found in the disclosure herein.

It is self-evident that the features mentioned above and those still to be explained below can be used not only in the combination specified in each case, but also in other combinations or alone, without departing from the scope of the present invention.

Preferred exemplary embodiments of the present invention are illustrated in the figures and explained in more detail in the following description.

### BRIEF DESCRIPTION OF THE DRAWINGS

FIG. 1 shows by way of example the structure of a control device according to the present invention in the form of a circuit diagram-like flow chart for the method according to the present invention.

FIG. 2 shows below a diagram explaining the calculation of the pilot control model steering torque, according to an example embodiment of the present invention.

### DETAILED DESCRIPTION OF EXAMPLE EMBODIMENTS

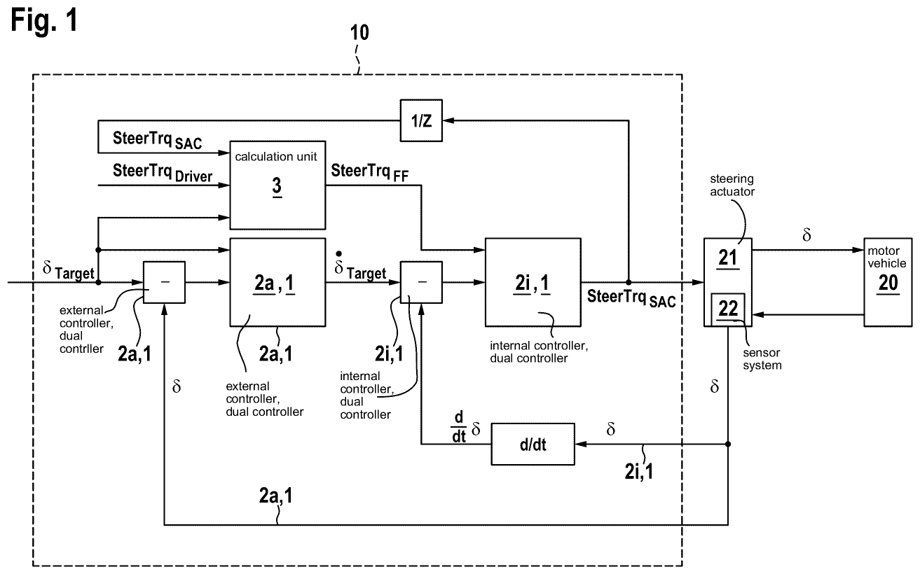

FIG. 1 shows by way of example the structure of a control device 10 according to the present invention for a motor vehicle 20, which is only indicated schematically, in the form of a circuit diagram-like flow chart. The control device 10 is configured for controlling a steering actuator 21 of the motor vehicle 20, which can be used to set a steering angle δ that specifies the direction of travel of the motor vehicle. Furthermore, the control device 10 is connected in a data-transmitting manner to a sensor system 22 of the steering actuator 21 for determining the currently set steering angle δ. For this purpose, the sensor system 22 can comprise a suitable steering angle sensor (not shown).

As explained above, the method according to the present invention serves to ascertain a controller steering torque SteerTrqSAC to be predefined for the steering actuator 21 of the motor vehicle 20. The steering actuator 21 can then convert the ascertained steering torque SteerTrqSAC into an assigned steering angle δ.

According to the method, the desired controller steering torque SteerTrqSAC is ascertained by means of a dual controller 1, which comprises an external controller 2a and an internal controller 2i connected downstream of the external controller 2a.

The steering angle δ(t) set by the steering actuator 21 in the motor vehicle 20 is fed to the external controller 2a as a control variable. The actual value of the steering angle δ is usually compared with a target value δ_{Target} and the control deviation (δ−δ_{Target}) is calculated by taking the difference. In accordance with FIG. 1, the external controller 2a outputs a target value for the time derivative of the steering angle d/dt δ_{Target}(t) as a manipulated variable, which in turn is provided to the internal-ontroller 2i as a control variable. The actual time derivative of the steering angle d/dt δ(t) is compared with the target value d/dt δ_{Target}(t) provided by the external controller 2a and the control deviation (d/dt δ(t)−d/dt δ_{Target}(t)) is calculated by taking the difference in the same way as for the external controller 2a. As shown in FIG. 1, the internal controller 2i calculates the desired controller steering torque SteerTrq_{SAC} as a manipulated variable, which is output to the steering actuator 21 as can be seen in FIG. 1. For the calculation of the controller steering torque SteerTrqSAC, the internal controller 2i in accordance with the figure is fed with a pilot control model steering torque SteerTrq_{FF}, which is determined by a calculation unit 3 integrated into the control loop of the internal controller 21 as an output variable as a function of the physical behavior of the steering actuator 21 in a time-dependent manner and, in particular, in real time.

Here, the physical state of the steering actuator 21 is modeled by a rotational single-mass spring damper with external excitation “Tₘₒₜ(t)_{SAC+DRIVER}.” The external excitation “Tmot(t)_{SAC+DRIVER}” of the spring damper is specified by the sum of a driver steering torque “SteerTrqDriver” exerted by the driver of the motor vehicle 20 and the controller steering torque “SteerTrq_{SAC}” to be predefined by the steering actuator 21. The two parameters “SteerTrq_{Driver}” and “SteerTrq_{SAC}” are fed to the calculation unit 3 as input variables.

When modeling the spring damper, the time-dependent steering angle δ (t) is a free parameter. Furthermore, four time-dependent spring damper model parameters J(t), D(t), C(t), Offs(t) are used for the modeling of the physical properties of the spring damper. Thus, the spring damper model parameters are variables that describe the rotational single-mass spring damper, i.e., the time-dependent rotational moment of inertia J=J(t), the time-dependent damping D=D(t), the time-dependent stiffness C=C(t) and a time-dependent offset=Offs(t) as time-dependent variables. The externally excited single-mass spring damper is described by the following differential equation:

$$J \ddot{δ} + D \dot{δ} + C δ + Offs = {Tmot ( t )}_{SAC + Driver}$$

The two spring damper model parameters J and D form the transient, i.e. dynamic, behavior of the steering actuator and the parameter C forms the quasi-stationary relationship between the steering angle δ and the steering torque acting on the steering actuator 21.

The values of the spring damper model parameters J(t), D(t), C(t), Offs(t) are estimated by means of a recursive compensation calculation. The estimation of the spring damper model parameters J(t), D(t), C(t), Offs(t) is effected in real time. This estimate is finally used to calculate the pilot control model steering torque SteerTrq_{FF} to be provided to the internal controller 2i.

The Internal controller 2i, which uses the target value of the change in steering angle d/dt δ_{Target} as a control variable, calculates the desired controller steering torque SteerTrqSAC to be fed to the steering actuator 21, taking into account the ascertained pilot control model steering torque SteerTrq_{FF} as a manipulated variable. In addition to the change in steering angle d/dt δ, the internal controller 2i is thus fed with the pilot control model steering torque SteerTrqFF as a reference variable, which depends on the dynamic physical behavior of the steering actuator 21 as explained above.

The externally excited single-mass spring damper is described by the following differential equation:

$$J \ddot{δ} + D \dot{δ} + C δ + Offs = {Tmot ( t )}_{SAC + Driver}$$

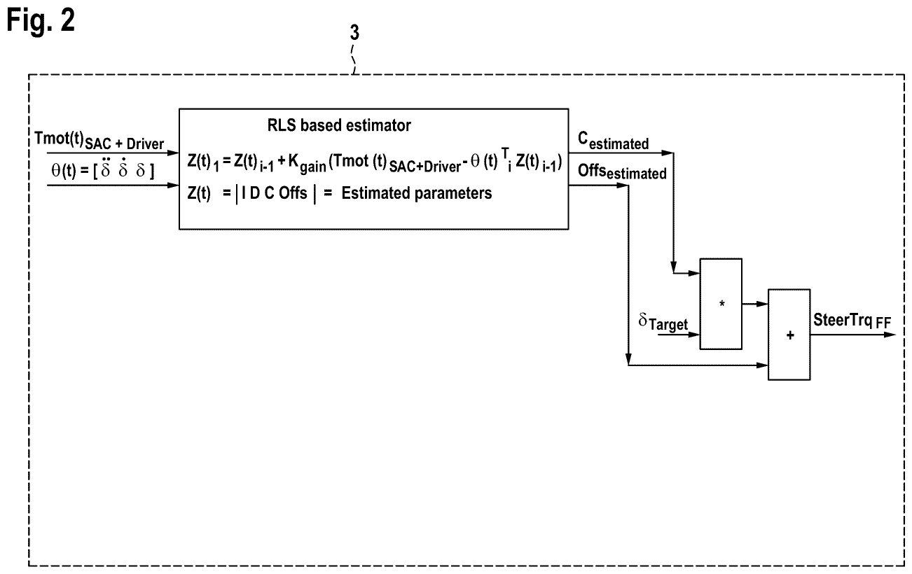

In the following, the diagram in FIG. 2, which schematically shows the calculation unit 3, is used by way of example to explain the calculation of the pilot control model steering torque.

For the recursive compensation calculation, the four spring damper model parameters J, D, C, Offs are considered as vectorial variables Z=Z(t):

Z(t)=[J(t)D(t)C(t)Offs(t)]

The steering angle δ(t) and its first and second time derivatives \dot{δ}, \ddot{δ} as input variables for the calculation unit can also be formulated as a vectorial variable e:

θ(t)=┌\ddot{δ}\dot{δ}δ┐

The recursive calculation Z(t) can be effected according to the following equation:

$${Z ( t )}_{i} = {Z ( t )}_{i - 1} + {{K}_{gain} ( t )}_{i} ( {Tmot ( t )}_{SAC + Driver} - {θ ( t )}_{i}^{T} {Z ( t )}_{i - 1} )$$

A Kalman filter can be used to estimate the values of the four spring damper model parameters J(t), D(t), C(t), Offs(t). Then, in the preceding equation, K_{Gain} is the Kalman gain, which is recursively defined as follows:

$${{K}_{gain} ( t )}_{i} = {P ( t )}_{i} * {θ ( t )}_{i} = {P ( t )}_{i - 1} {s ( t )}_{i} {( λ + {θ ( t )}_{i}^{T} {P ( t )}_{i - 1} {θ ( t )}_{i} )}^{- 1}$$

In the preceding equation, P(t)ᵢ is the positive definite covariance matrix defined as follows:

$${P ( t )}_{i} = ( I - {K}_{gain} ( t ) , {θ ( t )}_{i}^{T} ) {P ( t )}_{i - 1} \frac{1}{λ}$$

Here, λ is a weighting factor that is also known to a person skilled in the art as the “forgetting factor” and for which 0<λ<=1 applies.

From the variable Z(t) recursively estimated as explained above, the pilot control model steering torque SteerTrq_{FF} can be calculated or estimated by the calculation unit 3 as can be seen in FIG. 2 as follows:

$${SteerTrq}_{FF} ( t ) = C ( t ) * {δ}_{Target} ( t ) + Offs ( t )$$

Particularly preferably, the pilot control model steering torque SteerTrq_{FF} can be ascertained from the estimated stiffness C EST and the estimated offset OFFS EST as a function of an externally predefined target steering angle δ_{target}.

1-12. (canceled)

13. A method for ascertaining a controller steering torque to be predefined for a steering actuator of a motor vehicle, the method comprising the following steps:
ascertaining the controller steering torque using a dual controller, the dual controller including an external controller and an internal controller connected downstream of the external controller, including:
feeding a steering angle set by the steering actuator in the motor vehicle to the external controller as a control variable,
outputting, by the external controller, a target value of a time derivative of the steering angle as a manipulated variable, which is fed to the internal controller as a control variable, and
outputting, by the internal controller, the controller steering torque as a manipulated variable, wherein a pilot control model steering torque is provided to the internal controller for a calculation of the controller steering torque as a manipulated variable, which is determined in real time as a function of a physical behavior of the steering actuator a physical state of the steering device being modeled by a rotational single-mass spring damper with external excitation and with the steering angle and with at least one further spring damper model parameter characterizing a current physical state of the steering actuator, the at least one time-dependent spring damper model parameter being estimated using a recursive compensation calculation, and wherein the pilot control model steering torque is calculated from the estimate.

14. The method according to claim 13, wherein the pilot control model steering torque is calculated as part of a control loop of the internal controller.

15. The method according to claim 13, wherein the pilot control model steering torque is calculated as a function of the target value of the steering angle, the controller steering torque calculated by the internal controller, and a driver steering torque exerted by a driver of the motor vehicle.

16. The method according to claim 13, wherein, for the at least one spring damper model parameters, the following constants used in the rotational single-mass spring damper are estimated as time-dependent variables:
rotational moment of inertia J(t); and
damping D(t); and
stiffness C(t); and
an offset OFFS(t).

17. The method according to claim 16, wherein the estimation is effected in real time.

18. The method according to claim 16, wherein the pilot control model steering torque is ascertained from the estimated stiffness and the estimated offset, as a function of an externally predefined target steering angle.

19. The method according to claim 16, wherein the spring damper model parameters J(t), D(t), C(t), OFFS(t), are estimated using a Kalman filter.

20. The method according to claim 16, wherein the externally excited single-mass spring damper (Tmot(t)_{SAC+DRIVER}) is described by the following differential equation:
$$J \ddot{δ} + D \dot{δ} + C δ + Offs = {Tmot ( t )}_{SAC + Driver}$$

21. The method according to claim 16, wherein the spring damper model parameters J(t), D(t), C(t), Offs(t) are considered as vectorial variables Z=Z(t) for the recursive compensation calculation.

22. The method according to claim 13, wherein the external excitation of the spring damper is specified by a sum of a driver steering torque exerted by a driver of the motor vehicle and the controller steering torque to be predefined for the steering actuator.

23. A control device for a motor vehicle, the control device configured to ascertain a controller steering torque to be predefined for a steering actuator of a motor vehicle, the control device configured to:
ascertain the controller steering torque using a dual controller, the dual controller including an external controller and an internal controller connected downstream of the external controller, including:
feeding a steering angle set by the steering actuator in the motor vehicle to the external controller as a control variable,
outputting, by the external controller, a target value of a time derivative of the steering angle as a manipulated variable, which is fed to the internal controller as a control variable, and
outputting, by the internal controller, the controller steering torque as a manipulated variable, wherein a pilot control model steering torque is provided to the internal controller for a calculation of the controller steering torque as a manipulated variable, which is determined in real time as a function of a physical behavior of the steering actuator a physical state of the steering device being modeled by a rotational single-mass spring damper with external excitation and with the steering angle and with at least one further spring damper model parameter characterizing a current physical state of the steering actuator, the at least one time-dependent spring damper model parameter being estimated using a recursive compensation calculation, and wherein the pilot control model steering torque is calculated from the estimate.

24. A motor vehicle, comprising:
two front wheels and two rear wheels,
a steering actuator configured to set a steering angle in the front wheels that specifies a direction of travel;
a sensor system configured to determine a currently set steering angle; and
a control device that interacts with the steering actuator and with the sensor system, the control device configured to ascertain a controller steering torque to be predefined for the steering actuator of the motor vehicle, the control device configured to:
ascertain the controller steering torque using a dual controller, the dual controller including an external controller and an internal controller connected downstream of the external controller, including:
feeding the steering angle set by the steering actuator in the motor vehicle to the external controller as a control variable,
outputting, by the external controller, a target value of a time derivative of the steering angle as a manipulated variable, which is fed to the internal controller as a control variable, and
outputting, by the internal controller, the controller steering torque as a manipulated variable, wherein a pilot control model steering torque is provided to the internal controller for a calculation of the controller steering torque as a manipulated variable, which is determined in real time as a function of a physical behavior of the steering actuator a physical state of the steering device being modeled by a rotational single-mass spring damper with external excitation and with the steering angle and with at least one further spring damper model parameter characterizing a current physical state of the steering actuator, the at least one time-dependent spring damper model parameter being estimated using a recursive compensation calculation, and wherein the pilot control model steering torque is calculated from the estimate.
